(19) United States
(12) Patent Application Publication
(10) Pub. No.: US 2007/0235589 A1
(43) Pub. Date: Oct. 11, 2007

(54) Atmospheric ionizer for space rockets

(76) Inventor: Magnar J. Grande, Metairie, LA (US)

Correspondence Address: Magnar J. Grande, South, Apt. 209, 3728 West Esplanade Ave., Metairie, LA, 70002, US

(21) Appl. No.: 11/398,410

(22) Filed: Apr. 5, 2006

(51) Int. Cl. B64C 1/38

(52) U.S. Cl. 244/130

(57) ABSTRACT

The invention provides a method of reducing air resistance pressure to an object moving through the atmosphere. Basically, the device consists of pairs of electrodes that discharges a string of pre-charged capacitors at a high voltage level, thereby ionizing the air and producing a vacuum. Since capacitors are made up of multiple thin layers of sheet materials, the external surface of a rocket may be used to fabricate a number of capacitors that may be released during the flight, after use.

### BACKGROUND OF THE INVENTION

The invention relates to means and methods of reducing air resistance pressure when an object is moved through the atmosphere at steady or accelerated speed.

### DESCRIPTION OF DRAWING

The above object, together with its described features of the invention, will be apparent in light of the details of construction and use of the Atmospheric Ionizer.

FIG. 1 in the drawing depicts a top view of the Atmospheric Ionizer.

FIG. 2 in the drawing shows an elevation view of the Atmospheric Ionizer as well as a representation of a typical rocket.

### DESCRIPTION OF THE “IONIZER”

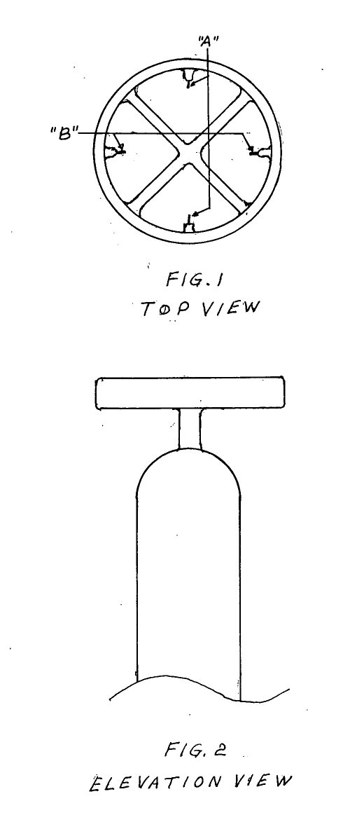

Referring to FIG. 1 of the drawing, the Atmospheric Ionizer comprises two (2) pairs (or any number) of electrodes shown as “A” and “B” on the drawing, one is connected to the negative side and the other, through a “on-off” switching arrangement to the positive side of a string of series connected capacitors that have been pre-charged to a high voltage level. The release of the high voltage to electrodes “A” and “B” will result in the ionizing of the air within the ring shown in FIG. 1. The result of this is that the air resistance pressure to an object moving through the atmosphere is reduced to a percentage of normal, depending on the voltage level applied. The point at which this procedure should be initialized would be at the time when the rocket is approaching the highest air resistance pressure experienced during the accelerated travel through the atmosphere. The capacitors may be released, like the fuel tank, during the flight.

What I claim in my invention is:

1. A means of reducing air resistance pressure to a moving object through the atmosphere.

2. A method of manufacturing capacitors on the external surface of a rocket.
